(19) United States
(12) Patent Application Publication
(10) Pub. No.: US 2014/0367938 A1
(43) Pub. Date: Dec. 18, 2014

(54) Corner Dolly Skate

(71) Applicant: Jimontanae Rax McBride, Suffolk, VA (US)

(72) Inventor: Jimontanae Rax McBride, Suffolk, VA (US)

(21) Appl. No.: 13/920,232

(22) Filed: Jun. 18, 2013

(51) Int. Cl. B62B 5/00

(52) U.S. Cl. CPC B62B 5/0093
USPC 280/79.11

(57) ABSTRACT

A heavy duty corner skate dolly is provided. The dolly frames includes a rectangular shaped plate with a L-shaped angle riser welded or permanently screwed to its top surface. The dolly plate's bottom surface includes a hole or a plurality of holes that are routed into the plates surfaces with a depth that is arrange to accept an industrial magnet or a plurality of industrial magnets that are partially incased in a metal plated finish and attached to the bottom surface of the plate by a fastening cap or a plurality of fastening caps that are pressed into or welded to the bottom surface. A plurality of stem fitted swivel caster wheels are mounted to the rectangular shaped plate by inserting each swivel caster wheel into its corresponding caster fastening holes at the frames bottom and bolting each swivel caster wheel at the frames top by a plurality of corresponding spring washers, lock washers, and hexagon shaped nuts.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The present invention relates to a heavy duty wheeled corner dolly skate. More specifically, the invention relates to a rectangular heavy duty corner dolly skate for manually moving and transporting heavy ferromagnetic and non-ferromagnetic square or rectangular shaped objects, containers or boxes.

### SUMMARY OF THE INVENTION

The present invention is a heavy duty wheeled corner skate dolly for manually moving and transporting heavy ferromagnetic and non-ferromagnetic square or rectangular shaped objects, containers or boxes. The frame of the dolly is comprised of a rectangular shaped plate with a L-shaped angle riser welded or permanently screwed to its top surface. The dolly plate's bottom surface includes a hole or a plurality of holes that are routed into the plates surfaces with a depth that is arrange to accept an industrial magnet or a plurality of industrial magnets that are partially incased in a metal plated finish and attached to the bottom surface of the plate by a fastening cap or a plurality of fastening caps that are pressed into or welded to the bottom surface.

The frame of the present invention includes a plurality of caster fastening holes at each corner. The caster fastening holes are arranged to accept a corresponding plurality of stem fitted swivel castors. The swivel castors wheels are mounted to the frame by inserting each swivel castor wheel into corresponding castor fastening holes at the frames bottom and bolting each swivel castor wheel at the frames top by a plurality of corresponding spring washers, lock washers, and hexagon shaped nuts.

### BRIEF DESCRIPTION OF THE DRAWING

FIG. 1 is an upper perspective view of a dolly according to the invention;

FIG. 2 is an expanded upper perspective view of a dolly according to the invention;

FIG. 3 is a bottom view of a dolly according to the invention.

FIG. 4 is an expanded bottom perspective view of a dolly according to the invention;

### DETAILED DESCRIPTION OF THE INVENTION

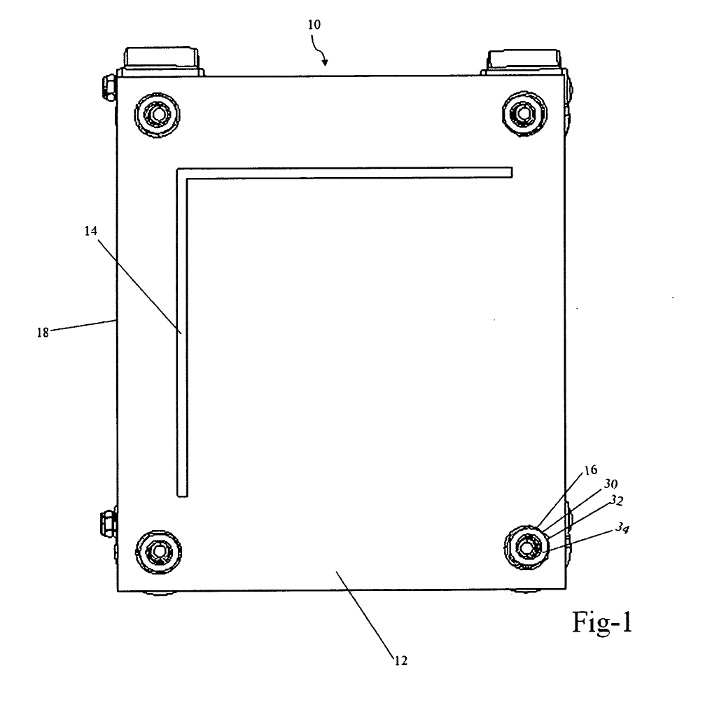

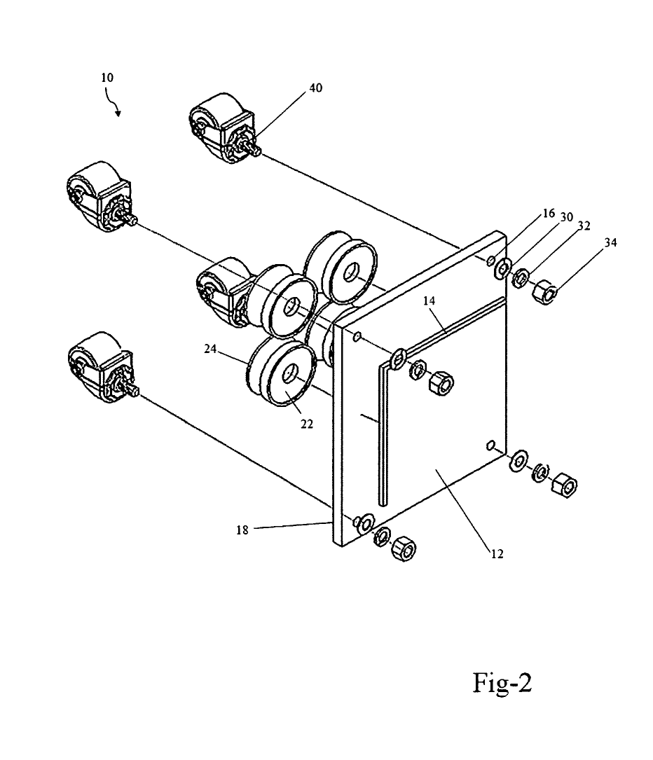

Referring now to the invention in more detail, in FIG. 1 and FIG. 2 there is shown a dolly 10 having a rectangular shaped plate 12 with a L-shaped angle riser 14 welded or screw to the top surface of the plate. A hole or plurality of holes 20 that are routed into the bottom 18 surface of the plate that are arrange to accept a corresponding heavy duty industrial magnet 22 or plurality of heavy duty industrial magnets 22 that are partially incased in a metal finish and attached to the bottom 18 surface of the plate by a fastening cap 24 or a plurality of fastening caps 24 that are pressed into or welded to the bottom surface.

In further detail, still referring to the invention of FIG. 1 and FIG. 2 the dolly 10 includes a plurality of caster fastening holes at each corner 16. The caster fastening holes 16 are arranged to accept a corresponding plurality of stem fitted swivel castors 40. The stem fitted swivel castors wheels 40 are mounted to the frame by inserting each swivel castor wheel 40 into corresponding castor fastening holes 16 at the frames bottom 18 and bolted at the frames top by a plurality of corresponding spring washers 30, lock washers 32, and hexagon shaped nuts 34.

The construction details of the invention as shown in FIG. 1 and FIG. 2 are that the dolly 10 may be made of heavy duty rated aluminum or of any other sufficiently rigid and strong material such as high-strength plastic, steel, metal, and the like. Further, the placement of the routed L-shape riser can alternate sides according to use.

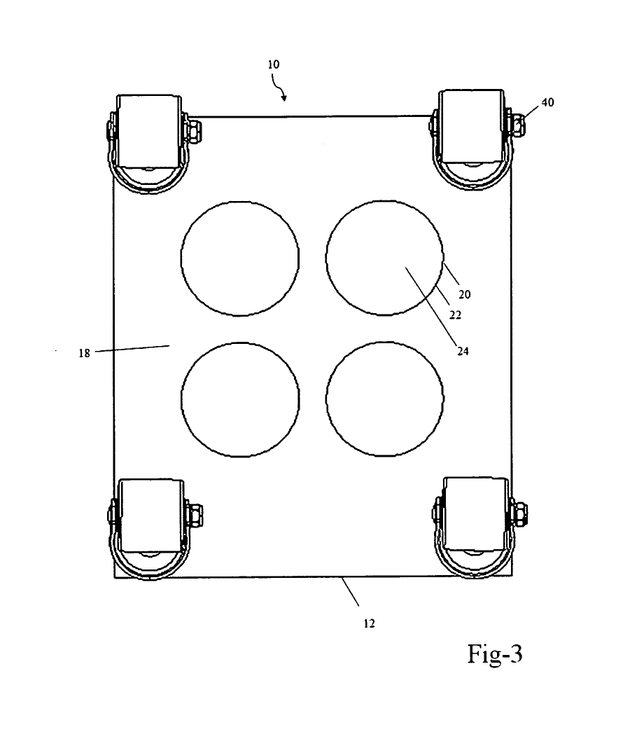

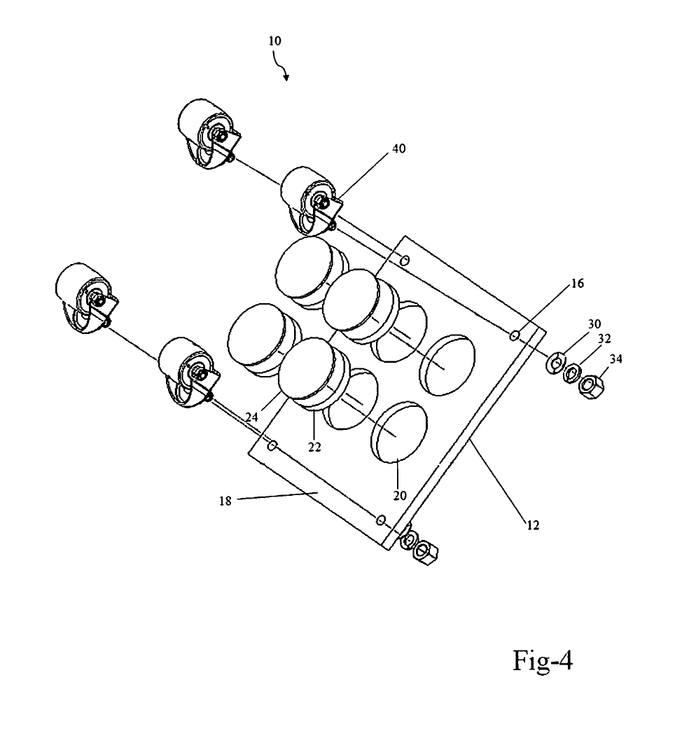

Referring now to FIG. 3 and FIG. 4 there is shown the underside of the dolly's 10 a rectangular shaped plate 12 which includes a plurality of caster fastening holes at each corner 16 and the bottom view of the plurality corresponding castor swivel wheels 40. FIG. 3 and FIG. 4 also shows a hole or plurality of holes 20 that are routed into the bottom 18 surface of the plate that are arrange to accept a corresponding heavy duty industrial magnet 22 or plurality of heavy duty industrial magnets 22 that are partially incased in a metal finish and attached to the bottom 18 surface of the plate by a fastening cap 24 or a plurality of fastening caps 24 that are pressed into or welded to the bottom surface.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention and determined only by a fair reading of the claims that follow.

What is claimed is:

1. A dolly comprising of:
a dolly frame having a heavy duty rectangular plate; and
a L-shaped angle riser that is welded or screwed to the top surface of the rectangular shaped plate.

2. The dolly according to claim 1, the rectangular plate having a hole or a plurality of holes routed into the rectangular shaped plate's bottom surface.

3. The dolly according to claim 1, the rectangular plate having an industrial magnet or a plurality of industrial magnets that are partially incased in a metal finish and inserted into the corresponding routed hole on the plate's bottom and attached to the bottom surface of the plate by a fastening cap or a plurality of fastening caps that are pressed into or welded to the bottom surface.

4. The dolly according to claim 1, a plurality of caster fastening holes in each corner for receiving a plurality of corresponding stem fitted castor swivel wheels which are inserted into the corresponding caster fastening holes at the bottom of the rectangular plate and bolted to the top of the rectangular plate by a plurality of corresponding spring washers, lock washers and hexagon shaped nuts.

5. The dolly according to claim 1, plurality of stem fitted castor swivels.
